(19) United States
(12) Patent Application Publication
(10) Pub. No.: US 2026/0222287 A1
(43) Pub. Date: Jul. 30, 2026

(54) INTERNET OF THINGS (IOT) EDGE HUB FOR CONVERTING IOT DEVICE DATA

(71) Applicant: Walmart Apollo, LLC, Bentonville, AR (US)

(72) Inventors: Shreya Pradip Solanke, Bangalore (IN); Chirag Anant Deshmukh, Pune (IN); Ramanujan Amaruviappan, Bentonville, AR (US); Saransh Sharma, ALIGARH (IN); Bhargav Bhat, Bangalore (IN)

(21) Appl. No.: 19/040,941

(22) Filed: Jan. 30, 2025

(51) Int. Cl. H04L 41/0806; G16Y 30/00

(52) U.S. Cl. CPC H04L 41/0806; G16Y 30/00

(57) ABSTRACT

A system for onboarding internet of things (IoT) devices. The system includes a storage device storing, for each of a plurality of IoT devices, a device profile associated with the IoT device; and an IoT edge hub comprising a processor and a computer-readable medium. The computer-readable medium stores instructions that are operative upon execution by the processor to, for each of the plurality of IoT devices: establish a low-level connection with the IoT device and receive a device identifier (ID) from the IoT device; retrieve, from the storage device, the device profile associated with the IoT device using the device ID; receive a data packet from the IoT device in a device data format associated with the IoT device; and using the device profile, convert the data packet to a converted data formatted in a predefined data format associated with the IoT edge hub.

### BACKGROUND

An Internet of Things (IoT) edge module can communicate using its specific communication protocol and transform incoming data of a recognized format to a different format, but may not be operable in IoT systems utilizing communication protocols or data formats outside of its defined boundaries. Thus, in IoT environments utilizing various and disparate IoT devices, multiple IoT edge modules may be implemented, each used to manage the IoT devices of the environment that the IoT edge module was made to be compatible with. In cases where a new IoT device is added to the IoT environment for which there is not a compatible IoT edge module, a new IoT edge module may be added to the environment to accommodate the new device. Implementing multiple IoT modules can be inefficient, time-consuming, and burdensome. Moreover, providing and managing edge modules in situations in which large number of IoT devices are desired can become impractical and cost prohibitive.

### SUMMARY

The disclosed examples are described in detail below with reference to the accompanying drawing figures listed below. The following summary is provided to illustrate some examples disclosed herein.

This disclosure includes various systems and methods for onboarding internet of things (IoT) devices. In some embodiments, a storage device stores, for each of a plurality of IoT devices, a device profile associated with the IoT device; and an IoT edge hub including a processor and a computer-readable medium. The computer-readable medium stores instructions that are operative upon execution by the processor to, for each of the plurality of IoT devices: establish a low-level connection with the IoT device and receive a device identifier (ID) from the IoT device; retrieve, from the storage device, the device profile associated with the IoT device using the device ID; receive a data packet from the IoT device in a device data format associated with the IoT device; and using the device profile, convert the data packet to a converted data formatted in a predefined data format associated with the IoT edge hub.

### BRIEF DESCRIPTION OF THE DRAWINGS

The disclosed examples are described in detail below with reference to the accompanying drawing figures listed below:

FIG. 1 illustrates a block diagram of a system for providing uniform device profiling for device onboarding in an internet of things (IoT) environment;

FIG. 2 is a block diagram illustrating an example architecture, executable by the system of FIG. 1, for providing uniform device profiling for device onboarding in an IoT environment;

FIG. 3 is a block diagram illustrating how various components of FIG. 2 are utilized in onboarding an IoT device;

FIG. 4 illustrates an example of an IoT device profile utilized by an IoT edge hub of FIG. 2 in onboarding an IoT device;

FIG. 5 illustrates another example of an IoT device profile utilized by the IoT edge hub of FIG. 2 in onboarding an IoT device;

FIG. 6 is a block diagram illustrating the conversion of data from an IoT device compliant with an IoT system specification or ontology associated with the IoT system;

FIG. 7 is a block diagram illustrating the conversion of data from an IoT device not compliant with an IoT system specification or ontology associated with the IoT system; and

FIG. 8 is a flowchart illustrating a method for onboarding an IoT device.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some embodiments, . . . ” For brevity and clarity of presentation, this implied leading clause is not repeated ad nauseum.

Internet of things (IoT) environments allow for efficient and effective transfer of data between various IoT devices of the environments. These IoT environments may incorporate IoT devices that are of different types, made by different manufactures, and/or operative using different communication protocols and data formats.

In order for data from various and disparate IoT devices to be analyzable or otherwise useful to other devices of an IoT environment, the data is converted to a common data format associated with the IoT environment, typically by multiple IoT edge modules of the environment each configured to communicate with only certain compliant devices in the IoT environment. IoT edge modules are industry-or manufacturer-specific and equipped according to the specific communication protocol and data format associated with the industry or manufacturer. An IoT edge module can communicate using its specific communication protocol and transform incoming data of a recognized format to a different format, but cannot be used in IoT systems utilizing communication protocols or data formats outside of its defined boundaries. Thus, in IoT environments utilizing various and disparate IoT devices, multiple IoT edge modules are implemented, each used to manage only the IoT devices of the environment that the IoT edge module is compliant with.

In cases where a new IoT device is added to the IoT environment for which there is not a compliant IoT edge module, a new edge module must be added to the environment to accommodate the device, adding significant cost, time, and effort in onboarding the new IoT device to the environment. Accordingly, onboarding a new IoT device to an IoT environment can be a significant hurdle for companies and other operators of IoT environments. Additionally, IoT environments with multiple edge modules present various inefficiencies, such as redundant memory and CPU, and hassles related to deployment and management of the various IoT edge modules, for example.

Aspects of the disclosure solve multiple problems that are necessarily rooted in computer technology, and render use of computing platforms more efficient by providing uniform device profiling for improving IoT device onboarding efforts. Specifically, some embodiments allow for an IoT edge module (also referred to as an IoT edge hub) to establish a low level-connection with an IoT device attempting to onboard to determine the type of the IoT device. The IoT edge hub then accesses a data storage device to locate and retrieve a device profile associated with the IoT device. Using the device profile, the IoT edge hub establishes communication with the IoT device using the device-specific communication protocol. Further, the IoT edge hub converts the data from the device format in a device-specific format to a predefined format associated with the IoT edge hub so that other devices of the IoT environment can analyze or otherwise use the data. This significantly improves IoT onboarding efforts, as an existing IoT edge hub can be used for onboarding a new device, thus eliminating incorporating new hardware as well as inefficiencies that come with it.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

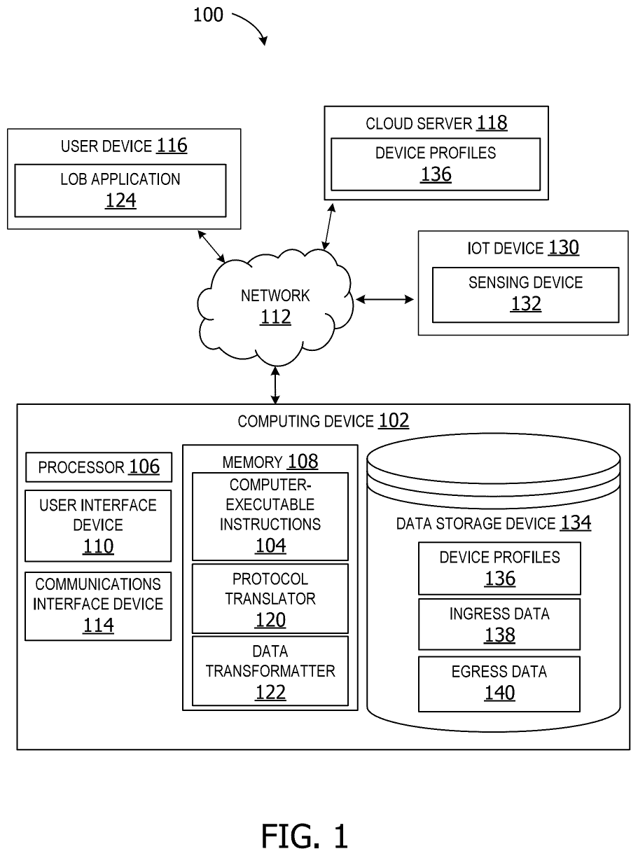

FIG. 1 illustrates a block diagram of a system 100 for onboarding IoT devices In the example of FIG. 1, the computing device 102 represents a device executing computer-executable instructions 104 (e.g., as application programs, operating system functionality, or both) to implement the operations and functionality associated with the computing device 102. The computing device 102, in some embodiments, comprises an edge computing module, system or hub for facilitating communication and data sharing within an IoT environment. Additionally, the computing device 102 can represent a group of processing units or other computing devices. In some embodiments, the computing device 102 has at least one processor 106 and a memory 108. Computing device 102, in other embodiments includes a user interface device 110.

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, processor 106 is programmed to execute instructions such as those illustrated in the figures.

The computing device 102 further has one or more computer-readable media such as the memory 108. The memory 108 includes any quantity of media associated with or accessible by the computing device 102. The memory 108 in these examples is internal to computing device 102 (as shown in FIG. 1). In other embodiments, the memory 108 is external to the computing device (not shown) or both (not shown). The memory 108 can include a read-only memory and/or memory wired into an analog computing device.

The memory 108 stores data, such as one or more applications, such protocol translator 120 configured facilitate communication with IoT devices of the system, such as IoT device 130, for example; and data transformatter 122 configured to convert data received from IoT device 130 to a format utilized and compliant with other devices of system 100, such as user device 116. The applications, when executed by processor 106, operate to perform functionality on the computing device 102. The applications can communicate with counterpart applications or services such as web services accessible via a network 112 or multiple communication networks 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

Network 112 is implemented by one or more physical network components, such as, but without limitation, routers, switches, network interface cards (NICs), and other network devices. Network 112 is any type of network for enabling communications with remote computing devices, such as, but not limited to, a local area network (LAN), a subnet, a wide area network (WAN), a wireless (Wi-Fi) network, or any other type of network. In this example, network 112 is a WAN, such as the Internet. However, in other embodiments, the network 112 is a local or private LAN.

In some embodiments, system 100 optionally includes a communications interface device 114. The communications interface device 114 includes a network interface card and/or computer-executable instructions (e.g., a driver) for operating the network interface card. Communication between the computing device 102 and other devices, such as but not limited to user device 116 and IoT device 130, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. User device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also host a line-of-business (LOB) application 124 for analyzing data transformed into an environment-compliant format by computing device 102.

The IoT device 130 represents any device executing computer-executable instructions. The IoT device 130 can be implemented as a mobile computing device, such as, but not limited to, a wearable computing device, a mobile telephone, laptop, tablet, computing pad, netbook, gaming device, and/or any other portable device typically incorporated into an IoT environment. The IoT device 130 includes at least one processor and a memory. IoT device 130 can include a sensing device 132 for gathering data, which the IoT device 130 can transmit to computing device 102.

The cloud server 118 is a logical server providing services to the computing device 102 or other clients, such as, but not limited to, the user device 116. Cloud server 118 is hosted and/or delivered via the network 112. In some non-limiting examples, cloud server 118 is associated with one or more physical servers in one or more data centers. In other embodiments, the cloud server 118 is associated with a distributed network of servers. Cloud server 118 can host a plurality of devices profiles each associated with a different IoT device of the IoT environment, such as IoT device 130, and are used by computing device 102 in communicating with and transforming data received from IoT device 130 into an environment-specific format compliant with other devices of system 100, such as user device 116.

The system 100 can optionally include a data storage device 134 for storing data, such as, but not limited to, device profiles 136 received from cloud server 118; ingress data 138 received from IoT device 130 in a format specific to IoT device 130, and egress data 140 formatted by computing device 102 in a data format compliant with other devices and applications of system 100, such as user device 116 and LOB application 124. The data storage device 134 can include one or more different types of data storage devices, such as, for example, one or more rotating disks drives, one or more solid state drives (SSDs), and/or any other type of data storage device. The data storage device 134 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other embodiments, the data storage device 134 includes a database.

The data storage device 134 in this example is included within the computing device 102, attached to the computing device, plugged into the computing device, or otherwise associated with the computing device 102. In other embodiments, data storage device 134 includes a remote data storage accessed by the computing device via the network 112, such as a remote data storage device, a data storage in a remote data center, or a cloud storage. Similarly, although bundling protocol translator 120 is depicted within computing device 102, according to various embodiments, bundling protocol translator 120 is implemented on a remote or cloud memory storage.

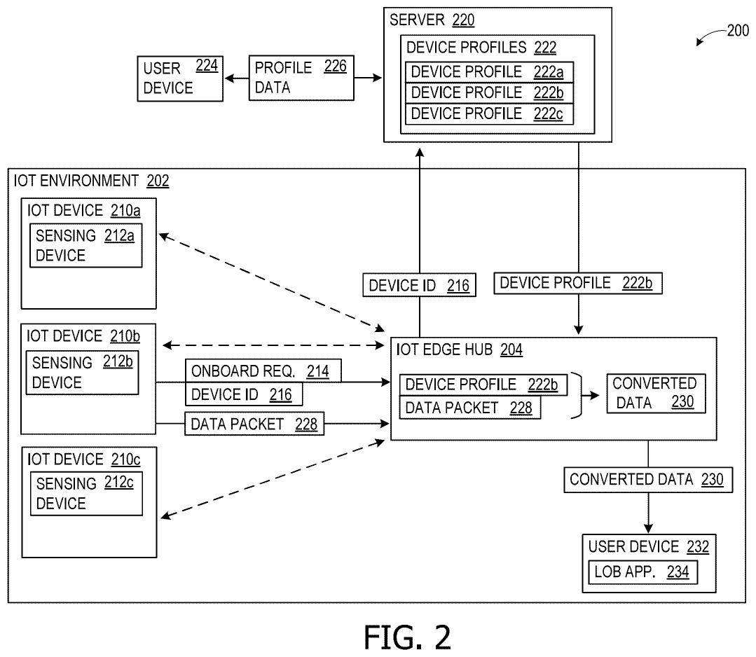

FIG. 2 is a block diagram illustrating an IoT system 200, substantially similar to system 100 in various aspects. IoT system 200 includes an IoT environment 202 where various components of IoT system 200 are deployed and used for sharing information with other components within IoT environment 202 and also with components outside of IoT environment 202. In some embodiments, IoT environment 202 is deployed at a location of facility owned or operated by an operator of IoT system 200. IoT environment 202 includes a dedicated IoT edge hub 204 (substantially similar to computing device 102) for facilitating connection and data transfer between IoT environment 202 devices so that the data gathered can be processed and analyzed using applications of the operator of the IoT system 200, such as LOB applications.

IoT environment 202 includes a plurality of IoT devices 210a, 210b, 210c, (each substantially similar to an IoT device 130) each operably coupled with IoT edge hub 204, as depicted in FIG. 2 by the dashed-line arrows. Those with skill in the art will understand that although three IoT devices 210 are shown, various embodiments of this disclosure include more or less than three IoT devices. Additionally, as will be discussed in greater detail below, each of the IoT devices 210 can be a different device-type, be manufactured by a different manufacturer, communicate according to a different protocol, and/or communicate data according to a different data format. That is to say, each of the plurality of IoT devices 210 can be distinct or disparate from any of the other of the IoT devices 210. Each IoT device can include a sensing device 212a, 212b, 212c for gathering data readings associated with the respective IoT device 210. As those with skill in the art will understand, while each IoT device 210 is shown as having one sensing device 212 for illustrative purposes, IoT devices 210 of this disclosure can include any number of a sensing devices 212.

Those with skill in the art will recognize that IoT devices 210 can include any device-type traditionally incorporated into IoT environments. As a purely illustrative and non-limiting example, IoT devices 210 can include warehouse or distribution center devices, such as conveyer devices, packaging devices, and forklifts or warehouse vehicles, for example; HVAC system devices; office devices such as printers, personal computing devices, and smart boards, for example; retail devices such as point-of-sale (POS) terminal and item scanning devices, for example; and kitchen devices such as coolers, freezers, food dispensing devices, and oven devices, for example. IoT environment 202 can incorporate any combination of such IoT devices 210 and be disposed in a facility housing the devices. That is, IoT environment 202 can include a facility or building housing IoT devices 210 and IoT edge hub 204.

Each of the IoT devices 210, when being onboard into the IoT environment 202, starts an onboarding process with IoT edge hub 204. In FIG. 2, the onboarding process is illustrated using IoT device 210b, but substantially the same or similar onboarding process is performed with IoT devices 210a, and 210c as well. As shown, IoT device 210b transmits an onboard request 214 to IoT edge hub 204 and thereby forms a low-level connection with IoT edge hub 204. Either with or separate from onboard request 214, IoT device 210b transmits a device identifier (ID) 216 identifying a device-type of IoT device 210b. In various embodiments, the low-level connection is formed for transmitting device ID 216. In various embodiments, the low-level connection can further include communication of data related to the IoT device 210b, such as sensor data, configuration parameters, and status information, for example. Device ID 216 can include any identifying information related to IoT device 210b such as, for example, a device-type, a device name, a device manufacturer, a device model number, and/or a device serial number.

Using the device ID 216, IoT edge hub 204 references a storage device to retrieve an associated device profile stored thereon. As shown, in some examples, the storage device is a server, which can be a cloud server 220 (substantially similar to cloud server 118) where a plurality of device profiles 222 (substantially similar to device profiles 136) are stored thereon. Although illustrated as a remote or cloud server located outside of the IoT environment, according to various embodiments, server 220 is stored locally within IoT environment 202 or even as part of IoT edge hub 204. Server 220 stores a plurality of device profiles 222 associated within IoT devices 210 that are part of IoT environment 202 and other IoT devices not part of IoT environment 202, such as devices employed in other IoT environments belonging to the operator of IoT system 200 or devices planned to be employed in IoT environment 202 or other environments belonging to the operator of IoT system 200.

Server 220 is accessible through a network connection by various computing devices belonging to the operator of IoT system 200, such as user device 224 for example. Using user device 224, a user can update, add, remove, or otherwise modify the plurality of device profiles 222, as shown with profile data 226.

As shown, using device ID 216 associated with IoT device 210b, IoT edge hub 204 retrieves the device profile 222b that corresponds with IoT device 210b (in FIG. 2, device profile 222a is for IoT device 210a; device profile 222b is for IoT device 210b; and device profile 222c is for IoT device 210c). That is, IoT edge hub 204 uses device ID 216 to identify the appropriate device profile 222b from server 220.

IoT edge hub 204 references device profile 222b to determine the communication protocol used by IoT device 210b, and forms a bi-directional communication connection with IoT device 210b according to the identified communication protocol. Through this communication connection, IoT edge hub 204 received a data packet 228, which can comprise any data related to IoT device 210b, such as statuses, events, or data related to or gathered by sensing device 212b. Data packet 228 is formatted according to a data format specific to IoT device 210b. IoT edge hub 204 references device profile 222b to determine the data format of data packet 228 and also to determine instructions for converting data packet 228 to an environment-specific format utilized by devices and applications of the IoT environment 202 downstream of IoT edge hub 204. IoT edge hub 204 converts data packet 228 to converted data 230 formatted in the environment-specific format using the instruction from device profile 222b.

IoT edge hub 204 then transmits converted data 230 to a downstream pipeline so that it can be processed, analyzed, or otherwise used by downstream devices and application compliant with the environment-specific format, such as user device 232 (substantially similar to device ID 216) and line-of-business (LOB) application 234 (substantially similar to LOB application 124). While user device 232 is illustrated within IoT environment 202, according to various environments, user device 232 is outside of IoT environment 202 and converted data 230 is sent to user device 232 over a network connection. Additionally, according to some examples, user device 232 is operatively coupled with server 220 to communicate 226, substantially similar to user device 224.

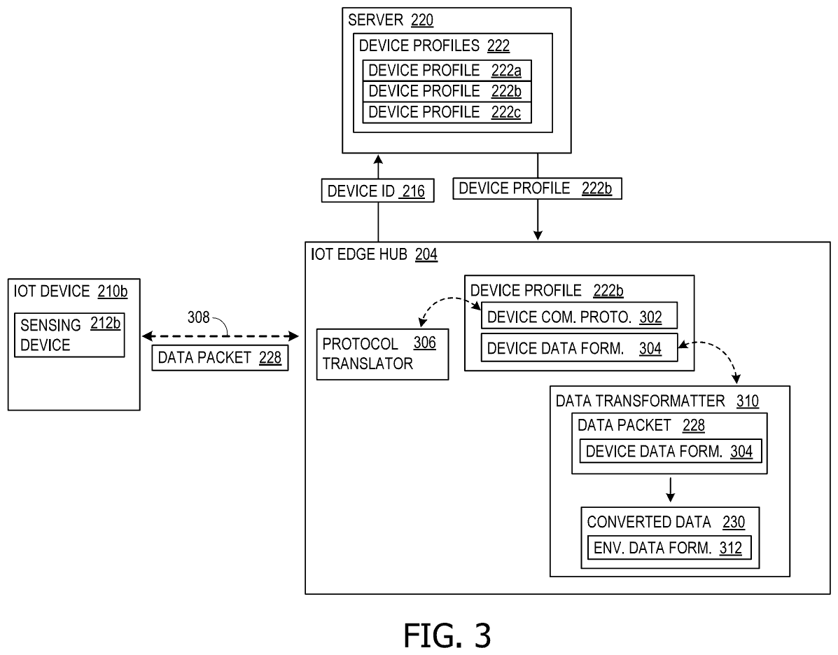

FIG. 3 is a block diagram illustrating additional details in IoT edge hub 204 converting data packet 228 to converted data 230. As previously discussed, using device ID 216, IoT edge hub 204 references server 220 to retrieve device profile 222b associated with device ID 216 and thus belonging to IoT device 210b. Device profile 222b, as will be discuss in greater detail in the following figures, contains various pieces of information related to IoT device 210b, such the communication protocol 302 and the device data format 304 employed by IoT device 210b for communicating and formatting information and data, such as data packet 228. Although profile 222b is used as an illustrative example, those with skill in the art will understand that each of the plurality of device profiles 222 includes details defining the communication protocol 302 and device data format 304 employed by their respective IoT devices 210.

Protocol translator 306 (substantially similar to protocol translator 120) references communication protocol 302 to determine the communication protocol utilized by IoT device 210b, and establishes a communication connection 308 with IoT device 210b using communication protocol 302. Using communication connection 308, IoT edge hub 204 receives data packet 228 from IoT device 210b. As those with skill int the art will recognize, protocol translator 306 is configured to bridge communication protocol disparities between the IoT devices 210 and other devices within IoT environment 202 so that the data gathered by the IoT devices 210 can be communicated to a human-machine interface (HMI), which can comprise user device 232 and/or LOB application 234, for example. That is, each of the IoT devices 210 can be configured to communicate according to a different protocol not understood by the HMI, and protocol translator 306 is configured to facilitate communication with each of the various IoT devices 210 for retrieving the associated data from each IoT device 210. As those with skill in the art will recognize, communication protocol 302 can comprise any of number of known communication protocols utilized by IoT devices, such as BACnet, MQTT, HTTP, OPC-UA, and Modbus TCP/IP, for example.

Data transformatter 310 (substantially similar to data transformatter 122) processes data packet 228 to convert the data packet 228 to converted data 230. Specifically, data transformatter uses device data format 304 from device profile 222b to determine the device format employed by IoT device 210b and how to transform it to converted data 230 utilizing an environment-specific data format 312 compliant with other downstream devices of 204, such as user device 232 and LOB application 234. As those with skill in the art will understand, data transformatter 122 converts data from one data format specific to an IoT devices 210 to another format. Here, the data transformatter 122 converts data to the environment-specific data format 312 so that it can be understood by devices of IoT system 200. According to various embodiments, the data transformation process can be referred to as an Extract, Transform load (ETL) or Extract, Load, Transform (ELT) process. According to various embodiments, device data format 304 is an OEM format specified by the manufacturer of the associated IoT device 210. In some examples, environment-specific data format 312 is a data format defined an IoT specification developed by an operator of IoT system 200 and employed at IoT environment 202 for use by downstream operator devices and application, such as user device 232 and LOB application 234, for example. As those with skill in the art will recognize, data packet 228 can be referred in as ingress data (such as ingress data 138) and converted data 230 can be referred to as egress data (such as egress data 140).

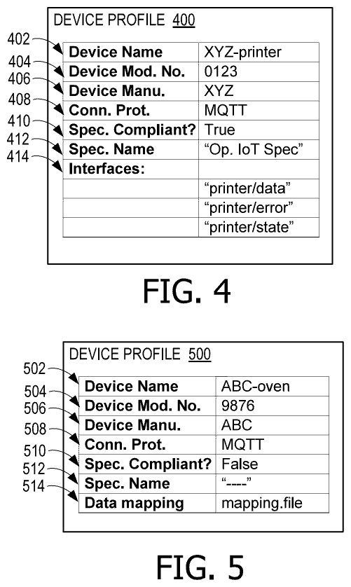

FIG. 4 illustrates an example of a device profile 400 of this disclosure, such as one of the device profiles 222 stored by server 220. As will become clear, device profile 400 is for an IoT devices 210 compliant with an operator IoT specification, while device profile 500 in FIG. 5 is for an IoT devices 210 not compliant with the operator IoT specification. As shown, device profile 400 includes a device name section 402, device model number section 404, and device manufacturer section 406 describing the name, model number, and manufacturer of the IoT device 210 associated with the profile. According to various embodiments, one, some, or all of the information in section 402-406 are included as part of device ID 216, and thus IoT edge hub 204 uses this information to identify the appropriate device profile from server 220. Here, as can be shown, the IoT device associated with device profile 400 is a printer with model number 0123 and manufactured by manufacturer XYZ. Device profile 400 further includes a connection protocol section 408 defining the connection protocol utilized by the IoT device 210 associated with device profile 400. Here, the connection protocol for the printer IoT device is MQTT. Connection protocol section 408 is used by protocol translator 306 in determining the communication protocol 302, as discussed in FIG. 3.

Device profile 400 further includes a specification compliance section 410 and a specification name section 412. Specification compliance section 410 reflects whether the devices associated with device profile 400 is compliant with an IoT specification or ontology employed by the operator of IoT system 200. According to some embodiments, specification compliance section 410 can be referred to as an ontology compliance section indicating the device's compliance with the ontology utilized by the IoT system 200. Here, specification compliance section 410 is labeled as “true”, indicating the device associated with device profile 400 is compliant with the IoT specification or ontology employed by the IoT system 200. Additionally, the specific IoT specification of IoT system 200 that the device associated with device profile 400 is compliant with is reflected in section 412, which as “Operator IoT Spec.”, indicating an IoT specification generated by the operator of IoT system 200 for IoT environments, such as IoT environment 202.

Because the device is categorized as spec.-compliant in section 410, device profile 400 further includes an interface section 414 outlining various interfaces included in data included in data packet 228 that are defined by device profile 400 as data that should be gathered for including in converted data 230. That is data packet 228 can include multiple pieces of distinct data, but only data defined by interface section 414 is to be pulled from data packet 228 and used as part of converted data 230 for processing and analyzing by downstream devices, such as user device 232. As shown, in this illustrative example, interface data related to “data,” “errors,” and “state” are to be taken from data packet 228 for conversion. According to some embodiments, interface section 414 can include certain events, alarms, errors, or other rules related to the associated device. As previously discussed, the interfaces can be defined, updated, or otherwise modified by an operator of the IoT system 200, such as by a user of user device 224.

FIG. 5 illustrates an example of a device profile 500 of this disclosure, such as one of the device profiles 222 stored by server 220. As previously mentioned, device profile 500 is for an IoT device 210 that is not compliant with an ontology of IoT specification employed as part of IoT system 200. As shown, device profile 500 includes identifier sections 502-508 substantially similar to corresponding sections 402-408 of device profile 400. As shown, for this illustrative example, the IoT device 210 associated with device profile 500 is an oven product type with a module number 9876 and manufactured by manufacturer ABC. Any of the information included in sections 502-506 can be included in device ID 216 for identifying device profile 500.

As previously mentioned, device profile 500 represents the profile for a device that is not compliant with the ontology or IoT specification supported or utilized by IoT system 200. As such, specification compliance section 510 is labeled as “false”, and specification name section 512 is blank, representing that the device associated with device profile 500 is not compliant with an IoT specification utilized by the IoT system 200. Device profile 500 further includes a data mapping section 514 specifying a file name that IoT edge hub 204, and specifically data transformatter 310, can use to convert data packet 228 to converted data 230. That is, because the IoT device 210 associated with device profile 500 is “non-compliant” with the IoT system 200 IoT specification or ontology, the data format used by the device must be converted to the environment-specific data format 312 using the mapping file identified in data mapping section 514. The mapping file can be a pointer to a local or remote file and can comprise any of a number of formats. According to some embodiments, the mapping file identified in data mapping section 514 is a schema JSON file, for example. Those with skill in the art will recognize that mapping section 514 can reference a mapping file according to various mapping file formats. The mapping file referenced in mapping section 514 can comprise a master copy of the mapping file stored at server 220 and/or can comprise a local copy of the mapping file stored at IoT environment 202 for local processing, such as at IoT edge hub 204 for example. An example of one such mapping file is discussed in greater detail in FIG. 7 in discussing data mapping file 702.

Those with skill in the art will recognize that device profiles 400, 500 are merely illustrative examples of possible device profiles 222 of this disclosure. According to various examples, device profiles 222 of this disclosure can include more or less than the sections describe din profiles 400, 500. Those with skill in the art will recognize that device profiles 222, including device profiles 400, 500, and any other configuration data in IoT system 200 can comprise any of various data formats that can be specific to a particular use case, such as, for example, JSON, XML, and YAML formats.

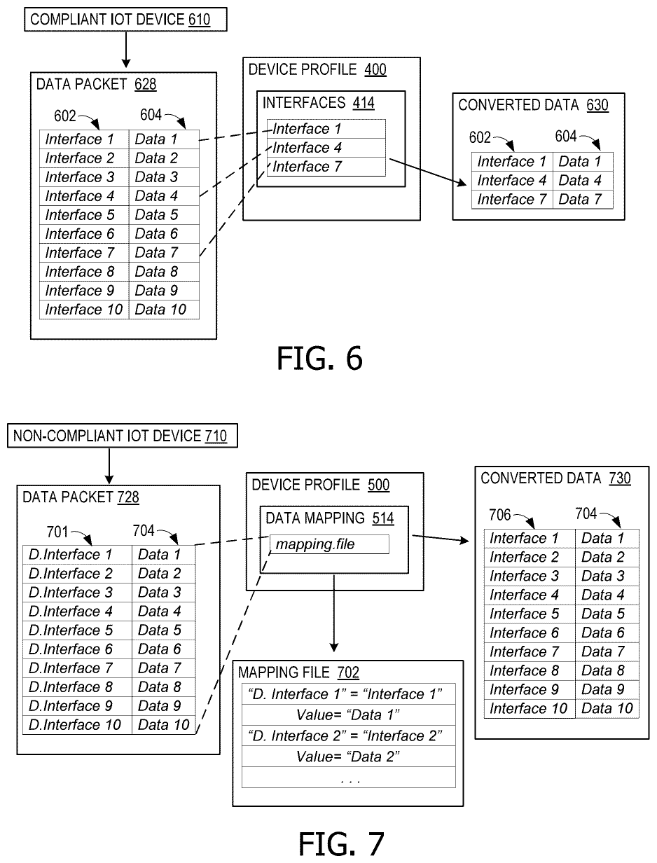

FIG. 6 is a block diagram illustrating how IoT edge hub 204 converts a data packet from a compliant IoT device 610, compliant with an ontology or IoT specification utilized by IoT system 200 and thus having a compliant device profile 400, to a converted data format. Specifically, as stated previously, the conversion can be performed by data transformatter 310. Here, compliant IoT device 610 provides a data packet 628, substantially similar to data packet 228. The data packet 628 includes various interface classifications related to compliant IoT device 610, such as for example sensors, statuses, errors, warnings, operations, events, and various other interfaces utilized by an IoT device. These are represented “Interfaces” numbered 1-10 in an interface 602 column. Each interface also has a value associated with the interface, illustrated as “Data” numbered 1-10 in value 604 column. Because the compliant IoT device 610 is compliant with the IoT system 200 ontology or IoT specification, the interface 602 and value 604 data may be in a format already usable for the converted data 230, such as environment-specific data format 312 for example. Thus, data transformatter 310 may perform little translation of the data, and interface section 414 of device profile 400 is used to select certain relevant pieces of data from data packet 628 for including as part of converted data 630 (substantially similar to converted data 230). As shown in this illustrative example, interface section 414 calls for gathering data related to interfaces 1, 4, and 7 from data packet 628. Converted data 630 includes interfaces 602 and associated values (interfaces 1, 4, and 7 and data 1, 4, and 7) defined by interface section 414. Thus, in some embodiments, converting data packet 628 to the environment-specific data format 312 utilized by IoT system 200 involves selecting from compliant data packet 628 interfaces specified by interface section 414 and may not involve translating the data from one format to another.

FIG. 7 is a block diagram illustrating how IoT edge hub 204 converts a data packet from a non-compliant device IoT device 710, not compliant with an ontology or IoT specification utilized by IoT system 200 and thus having a non-compliant device profile 500, to a converted data format. Specifically, as stated previously, the conversion can be performed by data transformatter 310. Here, non-compliant IoT device 710 provides a data packet 728, substantially similar to data packet 228. The data packet 728 includes various interface classifications associated related to compliant IoT device 710, such as for example sensor, statuses, errors, warnings, operations, events, and various other interfaces utilized by an IoT device. These are represented “D. Interfaces” numbered 1-10 in an interface 701 column. Interfaces of data packet 728 are illustrated with a “D.” before “Interfaces” to illustrate that the interface data is formatted according to a device-specific data format 304 specific to IoT device 710, and different from the environment-specific data format 312. Each interface also has a value associated with the interface, illustrated as “Data” numbered 1-10 in value 704 column.

Because the non-compliant IoT device 710 is not compliant with the ontology or IoT specification utilized by IoT system 200, data mapping must be performed to convert data packet 728 to converted data 730. As previously discussed, data mapping section 514 can be referenced by data transformatter 310 to determine the appropriate mapping file, such as mapping file 702 shown.

Data transformatter 310 utilizes mapping instructions to convert the data packet 728 in the device-specific format 304 to environment-specific data format 312. As shown, 702 defines that “D.Interface 1” used in the device specific format is the same as what environment-specific data format 312 calls “Interface 1” and has a value of “Data 1”, and so on. Thus, data transformatter 310 utilizes interface 701 to generate converted data 730 (substantially similar to converted data 230) with converted interfaces 706 in the environment-specific data format 312 and associated values 704.

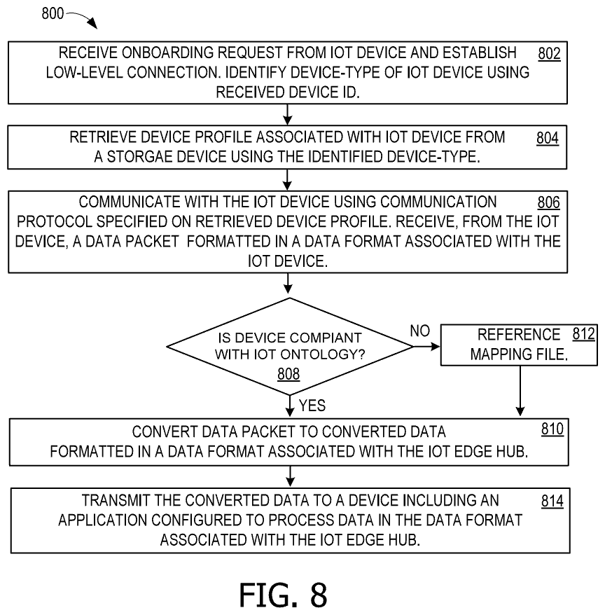

FIG. 8 is a flowchart illustrating a method 800 of onboarding IoT devices. Method 800 can begin at block 802 by IoT edge hub 204 receiving onboard request 214 from an IoT device 210 and establishing a low-level connection and thereby receiving device ID 216 for identifying the IoT device 210. Method 800 can continue to block 804 where, using device ID 216, IoT edge hub 204 retrieves a device profile 222 associated with the IoT device 210 from server 220. Method 800 can continue to block 806 where IoT edge hub 204 communicates with IoT device 210 according to a communication protocol 302 specified on device profile 222 and using protocol translator 306, and thereby receives a data packet 228 from the IoT device 210.

In block 808, if the device profile 222 indicates that the IoT device 210 is compliant with an IoT specification or ontology of IoT system 200, such as in the case of the compliant IoT device 610 and the compliant device profile 400, method 800 continues to block 810, where data transformatter 310 converts data packet 228 to converted data 230 formatted in environment-specific data format 312 using the device profile 222. Specifically, as shown in FIG. 6, data packet 628 from compliant IoT device 610 is converted to converted data 630 using device profile 400, as previously discussed.

In block 808, if the device profile 222 indicates that the IoT device 210 is not compliant with an IoT specification or ontology of IoT system 200, such as in the case of the non-compliant IoT device 710 and the non-compliant device profile 500, method 800 continues to block 812, where data transformatter 310 references a data mapping file 702 indicated by data mapping section 514 of device profile 500. Method 800 can then continue to block 810 where data transformatter 310 converts data packet 228 to converted data 230 formatted in environment-specific data format 312 using the data mapping file 702 identified in data mapping section 514 of device profile 222. Specifically, as shown in FIG. 7, data packet 628 from non-compliant IoT device 710 is converted to converted data 730 using data mapping file 702, as previously discussed. Method 800 can continue to block 814 where IoT edge hub 204 transmits converted data 230 to one or a plurality of devices or applications compatible with and configured to process or otherwise analyze data formatted in the environment-specific data format 312, such as user device 232 and LOB application 234, for example.

While method 800 illustrates blocks 802-814 occurring in certain orders, those with skill in the art will understand that blocks 802-814 can be performed according to any of a number of orders without departing from the scope of this disclosure. Additionally, according to various embodiments, method 800 can include more or less blocks than the blocks 802-812 depicted.

Those with skill in the art will recognize that the IoT system 200 and associated method 800 can be utilized any environment in which IoT environments are present. For example, in some embodiments, IoT environment 202 is deployed in a retailer facility, such as a store, warehouse, or distribution center belonging to or operated by a retailer. Thus, IoT edge hub 204 can be disposed on-site at the retailer facility and the plurality IoT device 210 can be any device local to the retail facility. As discussed above in greater detail below, IoT environment 202 allows for efficient onboarding of multiple disparate IoT devices 210, at least in part by utilizing a single IoT edge hub 204 at the facility that can onboard and provide IoT connectivity for each of the disparate IoT devices 210.

Although described in connection with an example computing device 102, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for onboarding internet of things (IoT) devices, comprising:
a storage device storing, for each of a plurality of IoT devices, a device profile associated with the IoT device; and
an IoT edge hub comprising a processor and a computer-readable medium storing instructions that are operative upon execution by the processor to, for each of the plurality of IoT devices:
establish a low-level connection with the IoT device and receive a device identifier (ID) from the IoT device;
retrieve, from the storage device, the device profile associated with the IoT device using the device ID;
receive a data packet from the IoT device in a device data format associated with the IoT device; and
using the device profile, convert the data packet to a converted data formatted in a predefined data format associated with the IoT edge hub.

2. The system of claim 1, further comprising a user device operably coupled with the IoT edge hub and including a line-of-business (LOB) application configured to process data formatted in the predefined data format,
wherein the instructions are further operative upon execution by the processor to transmit the converted data to the user device for processing by the LOB application.

3. The system of claim 1, wherein each of the plurality of IoT devices are configured to communicate with the IoT edge hub using a different device communication protocol.

4. The system of claim 3, wherein the different device communication protocols comprise at least two of BACnet, MQTT, HTTP, OPC-UA, and Modbus TCP/IP.

5. The system of claim 3, wherein, for each of the plurality of IoT devices, the computer-readable medium further stores instructions that are operative upon execution by the processor to:
determine the device communication protocol associated with the IoT device using the device profile associated with the IoT device; and
establish a communication connection with the IoT device using the device communication protocol.

6. The system of claim 1, wherein, for each of the plurality of IoT devices, the computer-readable medium further stores instructions that are operative upon execution by the processor to:
using the device profile, determine whether the IoT device is a compliant device compliant with an IoT specification or ontology utilized by the IoT system; and
in response to determining that the IoT device is a compliant device, convert the data packet to the converted data using an interface section of the device profile.

7. The system of claim 1, wherein, for each of the plurality of IoT devices, the computer-readable medium further stores instructions that are operative upon execution by the processor to:
using the device profile, determine whether the IoT device is a compliant device compliant with an IoT specification or ontology utilized by the IoT system; and
in response to determining that the IoT device is not a compliant device, convert the data packet to the converted data using a mapping file referenced by the device profile.

8. A method for onboarding internet of things (IoT) devices in an IoT system, comprising:
establishing, by an IoT edge hub, a low-level connection with each of a plurality of IoT devices and thereby receiving a device identifier (ID) from each of the plurality of IoT devices;
retrieving, for each of the plurality of IoT devices by the edge hub from a storage device, a device profile associated with the IoT device using the device ID;
receiving, by the IoT edge hub from each of the plurality of IoT devices, a data packet in a device data format associated with the IoT device; and
converting, by the IoT edge hub for each of the plurality of IoT device, the data packet to converted data formatted in a predefined data format associated with the IoT edge hub using the device profile.

9. The method of claim 8, further comprising transmitting, by the IoT edge hub, the converted data to a user device including a line-of-business (LOB) application configured to process data formatted in the predefined data format.

10. The method of claim 8, wherein each of the plurality of IoT devices are configured to communicate with the IoT edge hub using a different device communication protocol.

11. The method of claim 10, wherein the different device communication protocols comprise at least two of BACnet, MQTT, HTTP, OPC-UA, and Modbus TCP/IP.

12. The method of claim 10, further comprising:
determining, by the IoT edge hub for each of the plurality of IoT devices, the device communication protocol associated with the IoT device using the device profile associated with the IoT device; and
establishing, by the IoT edge hub for each of the plurality of IoT devices, a communication connection with the IoT device using the device communication protocol associated with the IoT device.

13. The method of claim 8, further comprising:
determining, for each of the plurality of IoT devices by the IoT edge hub using the device profile, whether the IoT device is a compliant device compliant with an IoT specification or ontology utilized by the IoT system; and
in response to determining that the IoT device is a compliant device, converting, by the IoT edge hub, the data packet to the converted data using an interface section of the device profile.

14. The method of claim 8, further comprising:
determining, for each of the plurality of IoT devices by the IoT edge hub using the device profile, whether the IoT device is a compliant device compliant with an IoT specification or ontology utilized by the IoT system; and
in response to determining that the IoT device is a not compliant device, converting, by the IoT edge hub, the data packet to the converted data using a mapping file referenced by the device profile.

15. A computer-readable medium storing instructions for onboarding internet of things (IoT) devices in an IoT system, the instructions operative by a processor to:
establish a low-level connection with each of a plurality of IoT devices and thereby receive a device identifier (ID) from each of the plurality of IoT devices;
retrieve, for each of the plurality of IoT devices from a storage device, a device profile associated with the IoT device using the device ID;
receive, from each of the plurality of IoT devices, a data packet in a device data format associated with the IoT device; and
convert, for each of the plurality of IoT devices, the data packet to converted data formatted in a predefined data format associated with the computer-readable medium using the device profile.

16. The computer-readable medium of claim 15, further storing instructions operative by a processor to:
transmit the converted data to a user including a line-of-business (LOB) application configured to process data formatted in the predefined data format.

17. The computer-readable medium of claim 15, wherein each of the plurality of IoT devices are configured to communicate with the computer-readable medium using a different device communication protocol.

18. The computer-readable medium of claim 17, wherein the different device communication protocols comprise at least two of BACnet, MQTT, HTTP, OPC-UA, and Modbus TCP/IP.

19. The computer-readable medium of claim 17, further storing instructions operative by a processor to:
determine, for each of the plurality of IoT devices, the device communication protocol associated with the IoT device using the device profile associated with the IoT device; and
establish, for each of the plurality of IoT devices, a communication connection with the IoT device using the device communication protocol associated with the IoT device.

20. The computer-readable medium of claim 15, further storing instructions operative by a processor to:
determine, for each of the plurality of IoT devices using the device profile, whether the IoT device is a compliant device compliant with an IoT specification or ontology utilized by the IoT system;
in response to determining that the IoT device is a compliant device, convert the data packet to the converted data using an interface section of the device profile; and
in response to determining that the IoT device is a not compliant device, convert the data packet to the converted data using a mapping file referenced by the device profile.
